(19) United States
(12) Patent Application Publication
(10) Pub. No.: US 2012/0269549 A1
(43) Pub. Date: Oct. 25, 2012

(54) IMAGE SIDE TENSIONER FOR XEROGRAPHIC BELT

(75) Inventor: Moritz P. Wagner, Rochester, NY (US)

(73) Assignee: XEROX CORPORATION, Norwalk, CT (US)

(21) Appl. No.: 13/091,172

(22) Filed: Apr. 21, 2011

(51) Int. Cl. G03G 15/00; B65G 23/44

(52) U.S. Cl. 399/165; 198/813; 198/814

(57) ABSTRACT

A belt tensioning device for minimizing tension variations in a moveable endless belt configured to be mounted for rotation about rollers mounted to a frame of an image printing device. The belt tensioning device includes a tension roll forced into contact with the image retaining side of the endless belt by a tension exerting mechanism. With the tension roll engaging the image side of the endless belt, a pair of mounted rollers combine with the tension roll to form an open loop for sharply turning the endless web from a first direction to a direction generally perpendicular to the first direction and back again to the first direction thereby tensioning the moveable endless belt and minimizing unused imaging space on the belt.

### BACKGROUND

1. Field of the Disclosure

This disclosed device and method relates generally to image producing devices such as photocopiers and printer devices utilizing photoreceptor belts and more particularly to a device and a method for controlling the tension in a photoreceptor belt utilized in such imaging devices.

2. Description of Related Art

The photoreceptors in imaging devices are usually multilayered drums or belts. When photoreceptor belts are utilized in image producing devices, the belt is typically mounted to run over a plurality of rollers or drums. Such photoreceptor belts are typically manufactured to specific tolerances so that the belt can be made taut when mounted to the rollers and subjected to a tensioning force provided by a tension producing device. Various devices and methods have been utilized to provide tension to belts in imaging devices. Typical belt tensioning devices include a belt engaging roller configured to be biased against the belt by a spring or weight mechanism that exerts a force having a component perpendicular to the belt.

In such devices, a compression spring oriented perpendicular to the belt is often utilized to exert the force. For example, In U.S. Pat. No. 7,155,144 and U.S. Pat. No. 5,946,533 there are shown typical high volume, color printing machines requiring belt tensioning. These systems generally show a tension roll that is resiliently urged into contact with the interior surface of photoconductive belt by a tension device mounted on a frame of the machine. The tension roll engages the belt between two of the rollers that support the movement of the belt throughout the machine. It should also be noted that in these prior art systems, as in the prior art imaging systems, in general, the tension roll urged into contact with the photoconductive belt, is urged into contact with the non-image side of the belt. This is the accepted practice in deference to the concern of adversely affecting the imaging operation if the tension roll makes contact with the imaging side of the belt.

### SUMMARY OF THE DISCLOSURE

However, unfortunately, there is an inordinate amount of photoconductive belt surface dedicated to this tensioning operation. From a printing viewpoint, the belt tension device in a Xerographic printer is a necessity, but it does not contribute directly to the printing function. Reducing the amount of belt length that is needed for the tensioning operation means less machine space is required for an equivalent machine, less size and weight of an equivalent machine, or more space available for other subsystems around the photoreceptor belt. More belt space available could be used, for example, to add additional color stations. Less belt space needed would at least minimize the likelihood of the belt exceeding tension tolerances, or increase the efficiency of belt rotation.

According to the disclosure, therefore, there is provided a belt tension system that reduces the amount of belt length that is needed for the tensioning operation and provides the opportunity to add or augment machine operations that can use additional belt space to increase the efficiency and quality of the printing system. According to another aspect, there is provided a belt tension system that reduces the footprint of the machine that provides more with less size and weight, or more space available for other subsystems around the photoreceptor belt. This could include additional color stations or simply improving the efficiency of belt rotation. According to another aspect of the disclosure, there is provided a belt tensioning system that provides tension to a photoreceptor belt by urging a tension roll into contact with the Imaging surface of the belt.

### BRIEF DESCRIPTION OF THE DRAWINGS

Various of the above-mentioned and further features and advantages will be apparent to those skilled in the art from the specific apparatus and its operation or methods described in the example(s) below, and the claims. Thus, they will be better understood from this description of these specific embodiment(s), including the drawing figures (which are approximately to scale) wherein:

FIG. 1 is an example of a prior art belt tensioning device; and

FIG. 2 is an embodiment of the belt tension device according to the disclosure.

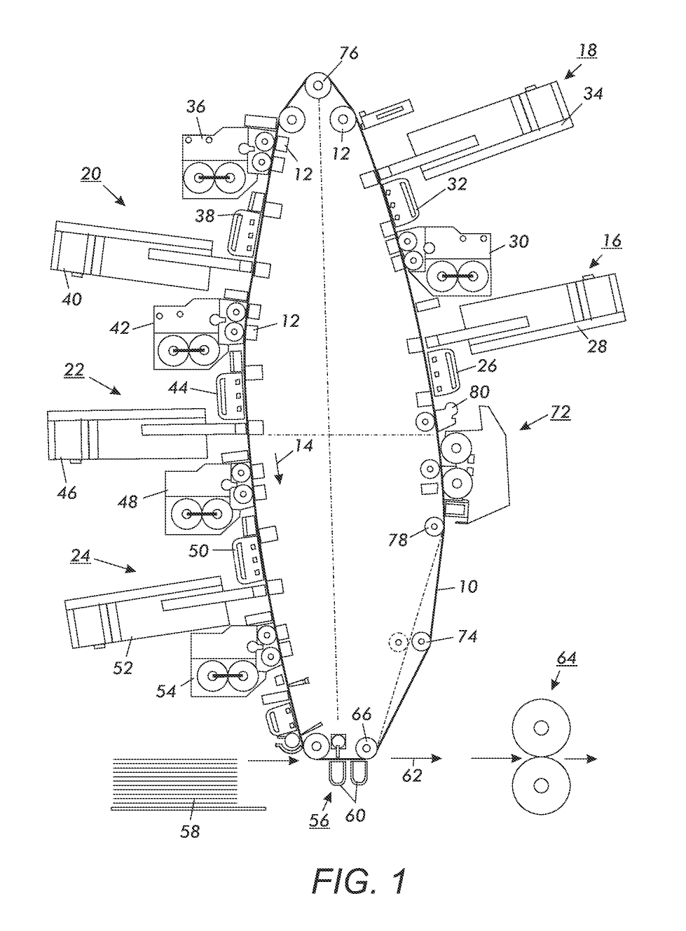

With reference to FIG. 1, there is shown a prior art belt tensioning device. In particular, there is shown a belt tensioning roll 74, resiliently urged into contact with the interior surface (non-image side) of photoconductive belt 10. The location of the tensioning roll is between stripping roller 66 and isolation roll 78 adjacent cleaning station 72. Tensioning roll 74 is movingly mounted on brackets. A spring resiliently urges tensioning roll 74 into contact with the interior surface (non-image side) of photoconductive belt 10 to maintain belt 10 at the appropriate tension.

Also there is shown a single pass multi-color printing machine, a typical high volume color printing architecture. This printing machine employs a photoconductive belt 10, supported by a plurality of rollers supporting along the belt path, illustrated at 12. Belt 10 advances in the direction of arrow 14 to move successive portions of the external surface of photoconductive belt 10 sequentially beneath five processing stations disposed about the path of movement and generally shown by the reference numerals 16, 18, 20, 22, and 24. These five processing stations include five charging devices 26, 32, 38, 44, and 50, five exposure devices 28, 34, 40, 46, and 52, and five developer units 30, 36, 42, 48, and 54. At transfer station 56, a receiving medium, i.e., paper, is advanced from stack 58 by sheet feeders and guided to transfer station 56. At transfer station 56, a corona generating device 60 sprays ions onto the back side of the paper. This attracts the developed multi-color toner image from the exterior surface of photoconductive belt 10 to the sheet of paper. Stripping assist roller 66 contacts the interior surface of photoconductive belt 10 and provides a sufficiently sharp bend in order that the beam strength of the advancing paper strips from photoconductive belt 10. A vacuum transport moves the sheet of paper in the direction of arrow 62 to fusing station 64.

FIG. 1 illustrates the prior art of urging a belt tensioning roll 74, into contact with the interior surface (non-image side) of photoconductive belt 10, not the image side. It is obvious, also, from FIG. 1 that the length of belt between stripping roller 66 and isolation roll 78 adjacent cleaning station 72 is significant. This is the length of belt that is dedicated to the belt tension system. As shown, the belt tension portion of web length takes up about ⅙^{th} of the total circumference of the belt. This is space that is unusable for the imaging operation, space that can be eliminated and thus reduce the size and cost of the printer or that can be used, for example, for additional processing stations.

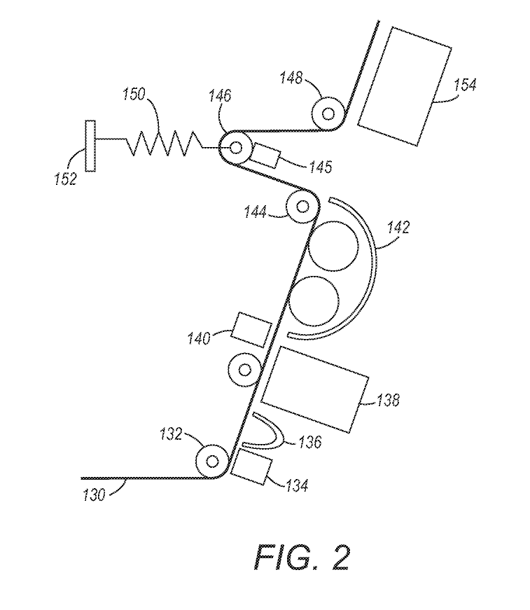

With reference to FIG. 2, there is shown, in general, a portion of an endless web in a high volume, color printing system, and, in particular, an endless belt tension system in accordance with the disclosure. There is shown an endless belt 130 moving in the direction from the bottom of the drawing to the top of the drawing, through a portion of the printing system stages. Stripper roll 132 and stripper fingers 134 insure that a developed copy sheet is suitable stripped from the belt and transported away from the belt 130 to a suitable not shown fuser device. The belt then continues to travel through a suitable clean and erase process.

One skilled in the art will appreciate that while the multi-color developed image has been disclosed as being transferred to paper, it may be transferred to an intermediate member, such as a belt or drum, and then subsequently transferred and fused to the paper. Furthermore, while toner powder images and toner particles have been disclosed herein, one skilled in the art will appreciate that a liquid developer material employing toner particles in a liquid carrier may also be used.

Invariably, after the multi-color toner powder image has been transferred to the sheet of paper, residual toner particles remain adhering to the exterior surface of photoconductive endless belt 130. Thus, the belt moves past a pre-clean charge 136, sensors 138, and a pre-clean erase 140. At cleaning station 142, the residual toner particles are removed from belt 130. The belt 130 then moves to a first tension support roll 144 providing a sharp angle turn of the belt to the tension roll 146. The tension roll 146 loops the belt in a U turn direction to a second tension support roll 148. This U shaped, open loop is shown generally at 147. The belt then continues to a first imaging station starting with charger 154.

This open loop 147 along with the support rolls 144 and 148 and tension roll 146 enable a generally perpendicular protrusion of the belt to provide tension and yet significantly reduce the length of belt required to maintain suitable tension on the belt. As shown, there the tension roll 146 is connected to a force exerting mechanism, illustrated at 150, in turn coupled to a frame 152. The first and second tension support rolls 144, 148 and the tension roll 146 form the open loop 147 for sharply turning the endless web from a first direction, leading to roll 144, to a direction generally perpendicular to the first direction, and back again to (approximately) the first direction (could be a larger or smaller angle depending on the design requirements of the machine), shown leading away form roll 148 thereby tensioning the moveable endless belt and minimizing unused space on the endless web 130. The support rolls 144 and 148 are on the line of straight movement of the belt to turn, then return the direction of the belt, to maintain printing integrity. A roller cleaning device, such as a pad or brush, is illustrated at 145 touching the tension roll 146.

It should be noted that the belt tension system, illustrated at 150 comprises a tension urging element shown at 152 secured to a frame 154 and connected to tension roll 146, and support rolls 144 and 148. However, many other suitable tensioning mechanisms are contemplated within the scope of this disclosure. It should also be noted that it takes about 70 mm of web length to provide the tension system in accordance with the disclosure.

It should also be noted that this system has the advantage of the pre-clean, erase, and clean steps preceding the belt tension process in the direction of the belt. This reduces contamination related to the tension process. As shown, the tension roll 146 is in contact with the image side of the belt 130, although the remaining elements of the tension process can be suitably located on the non-image side. Further note that in some applications it might be advantageous to have the tensioner right after the stripper roll 132, and increase the wrap on the stripper roll (which may also be a drive roll and therefore increase the drive capacity of the system). This could be particularly useful in “lower image quality” machines where one would not have the sensor module 138. In this case the tension roller may pick up some toner, but that may be minimized by appropriately biasing the roller and by using a cleaning pad on the roller.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A tensioning device for minimizing tension variations in a moveable endless belt configured to be mounted for rotation about rollers mounted to a frame, the endless belt having an imaging side and a non-imaging side, the tensioning device comprising:
a belt tension member for movement into contact with the moveable endless belt;
a force exerting mechanism coupled to the frame, and
first and second tension support rolls, the force exerting mechanism urging the belt tension member into contact with the imaging side of the moveable endless belt, the first and second tension support rolls and the belt tension member forming an open loop for sharply turning the endless web and thereby minimizing the length of the endless web suitable for belt tension.

2. The device of claim 1, wherein the belt tension member has a convex surface for forming a wrap angle with the imaging side of the moveable endless belt.

3. The device of claim 1, wherein the force exerting mechanism includes an extension spring.

4. The device of claim 1, wherein the device is part of an imaging machine having a cleaning station wherein the open loop is positioned after the cleaning station in the direction of movement of the endless belt.

5. The device of claim 1, wherein the open loop is an elongated U shape, the first and second tension support rolls forming the ends of the U and the belt tension member engaging the middle portion of the U shaped open loop.

6. The device of claim 1, wherein the open loop is adapted for sharply turning the endless web from a first direction to a direction generally perpendicular to the first direction and back again to the first direction.

7. A tensioning device for minimizing tension variations in a moveable endless belt having a desired tension setting and configured to be mounted for rotation about rollers mounted to a frame, the endless belt having an image side and a non-image side, the tensioning device comprising:
a belt tension member for mounting in relation to the movement of the moveable endless belt and being movable into contact with the moveable endless belt; and
a force exerting mechanism urging the moveable member into contact with the image side of the moveable endless belt thereby tensioning the moveable endless belt.

8. The device of claim 7, including first and second tension support rolls, the tension support rolls supporting a portion of the endless belt, the tension support rolls and the belt tension member forming an open loop wherein the open loop is an elongated U shape, the first and second tension support rolls forming the ends of the U and the belt tension member engaging the middle portion of the U.

9. The device of claim 8, wherein the open loop is positioned after a cleaning station in the direction of movement of the endless belt.

10. The device of claim 7, wherein the force exerting mechanism includes a spring device.

11. A tensioning device for minimizing tension variations in a moveable endless belt configured to be mounted for rotation about rollers mounted to a frame, the tensioning device comprising:
a belt tension member for movement into contact with the moveable endless belt;
a force exerting mechanism coupled to a frame, and
first and second tension support rolls, the force exerting mechanism urging the belt tension member into contact with the moveable endless belt, the first and second tension support rolls and the belt tension member forming an open loop in the path of the endless belt.

12. The device of claim 11, wherein the open loop enables turning the endless web from a first direction to a direction generally perpendicular to the first direction and back again to the first direction thereby minimizing the length of the endless belt needed for the belt tension operation.

13. The device of claim 11, wherein the open loop is an elongated U shape, the first and second tension support rolls forming the ends of the U and the belt tension member engaging the middle portion of the elongated U shape.

14. The device of claim 11, wherein the endless belt has an imaging side and a non-imaging side and the belt tension member contacts the imaging side of the endless belt.

15. The device of claim 11, wherein the open loop is positioned after a cleaning station in the direction movement of the endless belt.
